(19) United States
(12) Patent Application Publication
(10) Pub. No.: US 2003/0140030 A1
(43) Pub. Date: Jul. 24, 2003

(54) Operating method for a reception computer

(76) Inventors: Thomas Birkhoelzer, Radolfzell (DE); Frank Krickhahn, Herzogenaurach (DE); Juergen Vaupel, Weisendorf (DE)

Correspondence Address: SCHIFF HARDIN & WAITE, 6600 SEARS TOWER, 233 S WACKER DR, CHICAGO, IL, 60606-6473, US

(21) Appl. No.: 10/306,194

(22) Filed: Nov. 27, 2002

(30) Foreign Application Priority Data
Nov. 29, 2001 (DE) 10158543.8

(51) Int. Cl. G06F 17/30

(52) U.S. Cl. 707/1

(57) ABSTRACT

In an operating method for a reception computer, the reception computer, via a computer network or a point-to-point connection, receives voice data from a user computer that are transmitted encrypted, deciphers the communicated, encrypted voice data and produces a text datafile corresponding to the deciphered voice data.

### BACKGROUND OF THE INVENTION

1. Field of the Invention

The present invention is directed to an operating method for a reception computer.

2. Description of the Prior Art

Increasing numbers of reports, memos, briefs, etc., i.e. writings in general, are being produced in various fields of modern life. Often, the content of the writing is first spoken onto a dictating machine for producing the writing and is then transcribed by a typist. It is also known to dictate such a text to a computer by means of a speech recognition system. In this case, the computer produces a text datafile directly on the basis of the input voice data.

The above-described procedures have in common the production of the text datafile that ensues locally, i.e. in the proximity of the dictating person.

It is also known to store spoken words on magnetic tapes or the like by means of a dictating machine and to send the magnetic tapes through the mail. In this case, corresponding text datafiles are likewise determined by a typist (usually with a playback device and a PC separate therefrom). In this case, however, the typist is at a location remote from the dictating person.

British Specification 2 323 693 discloses an operating method for a reception computer, wherein the reception computer receives voice data communicated from a user computer via a computer network or a point-to-point connection and produces a text datafile corresponding to the communicated voice data. The method disclosed in this publication operates rather well but is capable of being improved.

The voice data are thus communicated to the reception computer in a simple way, namely by means of ordinary digital data transmission, and are converted at the reception computer into a corresponding text datafile.

### SUMMARY OF THE INVENTION

An object of the present invention is to provide an operating method for a reception computer of the type described above, wherein voice data produced remote from the reception computer can be simply and efficiently converted into a text datafile, while still assuring data security.

This object is achieved in a method of the type initially described wherein the reception computer receives voice data from a user computer that are transmitted encrypted, and wherein the reception computer deciphers the communicated voice data and produces a text datafile corresponding to the deciphered voice data.

It is possible for the reception computer to interactively output the communicated voice data to an operator of the reception computer via an acoustic output device and to produce the text datafile on the basis of inputs by the operator. In this case, the operating method includes at least the functionalities of a dictating machine and a text processing system or editor. It is thus possible to interrupt the continuous playback of the voice data at an arbitrary point and continue it again later. It is also possible to go back a bit in the voice data and continue the playback from there.

Alternatively, it is possible for the reception computer to produce the corresponding text datafile automatically on the basis of the communicated voice data. In this case, the operating method includes the functionality of a speech recognition system with which a text datafile can be produced on the basis of the corresponding spoken words.

In an embodiment the reception computer receives the communicated voice data as a datafile, which allows the data to be administered and manipulated more easily. In particular, it is then possible in a simple way for the reception computer to produce the text datafile offset in time from the reception of the voice data.

The reception computer can output the text datafile to the operator in optical form via an output medium, allowing the text datafile to be modified, particularly corrected, by an operator of the reception computer in a simple way. The correction can be optimized by an acoustic playback of the voice data in addition to the optical output (via a monitor or a printer).

It is possible, for example, to print out the voice datafile that has been produced and to store it on a mobile data carrier (diskette and the like) and to then send it in physical form. Preferably, however, the reception computer transmits the text datafile directly to a third-party computer. The third-party computer can be an arbitrary computer. In particular, it can also be the user computer.

In a further embodiment, the reception computer transmits the text datafile to the third-party computer only when the user computer has previously sent the reception computer a confirmation, then it is assured that the transmission of the text datafile is proper. The confirmation can be a confirmation of the destination location of the text datafile and/or a confirmation about the content of the text datafile.

The confirmation is especially secure when the confirmation has a digital signature.

In a further embodiment the reception computer encrypts the text datafile before the transmission to the third-party computer, so data security is also assured in the communication between the reception computer and the third-party computer.

In another embodiment, the reception computer accepts an identifier from the user computer in advance and automatically compares the identification to an authorization stored in a user list and accepts the voice data only given a coincidence. Then it is assured in a simple way that only authorized users can communicate voice data to the reception computer.

In a version of this embodiment, in the event of a coincidence, the reception computer first automatically checks a counter reading allocated to the identification for satisfaction of a counter reading condition and accepts the voice data only when the counter reading condition has been satisfied. A user who is otherwise authorized can be excluded from the use of the reception computer as an exception in a simple way.

The counter reading condition can be satisfied when the counter reading exceeds a threshold, so the determination of the counter reading condition is especially simple. Optionally, the threshold can be identification-specific or the same for all counter readings.

The reception computer can automatically, periodically decrement the counter readings allocated to the authorizations by change values, so a type of subscription can be realized in a simple way. Optionally, the change values can thereby be authorization-specific or the same for all counter readings.

If the reception computer decrements a counter reading allocated to the identification by a voice data-specific change value, a project-specific adaptation of the counter reading can be realized in a simple way. For example, this change value can be dependent on the scope of the communicated voice data and/or on the scope of the determined text datafile.

The reception computer can archive the voice data and/or the text data, allowing a documentation of the activities that have been carried out and, as warranted, a subsequent request for a text datafile as well in a simple way.

The archived voice data and/or the archived text datafile can in turn be automatically deleted after the expiration of a storage time, so the required memory capacity is kept within limits.

The voice data can be associated with a patient-related medical situation, so the operating method has an especially large field of application.

The reception computer can communicate with the user computer, and possibly with the third-party computer as well, via a point-to-point connection, so the data security is higher than given a communication via a computer network.

The reception computer can communicate with the user computer, and possibly with the third-party computer as well, according to an Internet protocol, so well known, standard transmission protocols can be utilized for the communication of the data.

### DESCRIPTION OF THE DRAWINGS

FIG. 1 illustrates a computer system for implementing the inventive operating method.

FIG. 2 illustrates a user list for use in the inventive operating method.

FIG. 3 illustrates a monitor presentation in the inventive operating method.

FIGS. 4-8 are flowcharts for explaining the inventive operating method.

### DESCRIPTION OF THE PREFERRED EMBODIMENTS

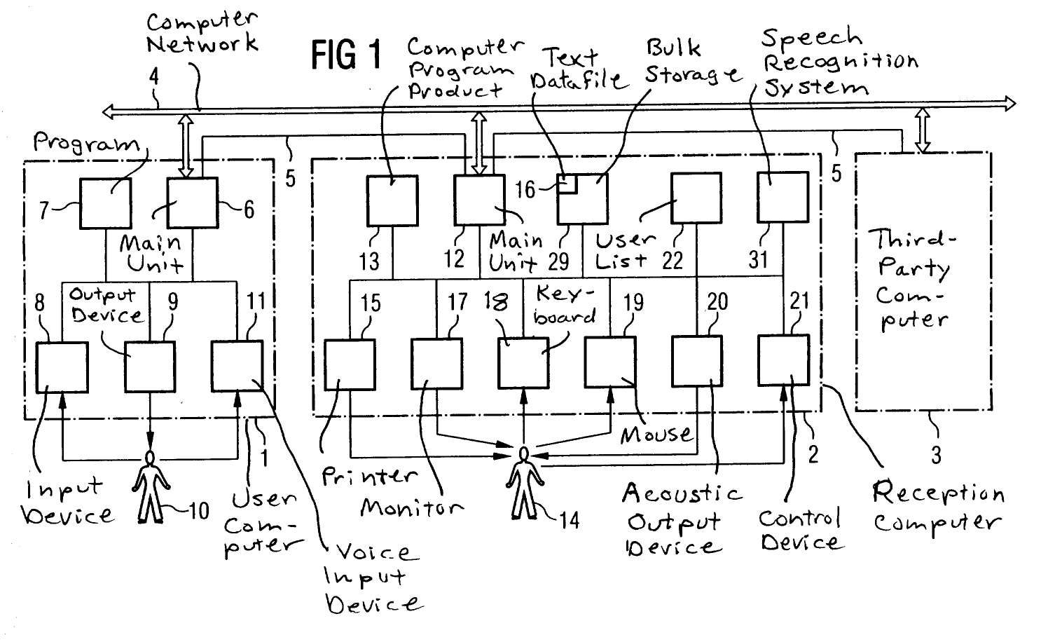

As shown in FIG. 1, a number of computers 1 through 3 are connected to a computer network 4. The computer network 4 can optionally be a local computer network (LAN) or a global computer network (for example, the Internet). The computer 1 is a user computer, the computer 2 is a reception computer, and the computer 3 is a third-party computer. The reception computer 2 also can be connected to the user computer 1 and the third-party computer 3 via point-to-point connections 5.

The communication of the reception computer 2 with the user computer 1 and the third-party computer 3 ensues via protocols that are standard for the Internet, for example for an e-mail or according to the http protocol.

The user computer 1 has a main unit 6. The main unit 6 runs a program 7. In the framework of the execution of the program 7, the main unit 6 communicates with a user 10 via an input device 8 and an output device 9. The main unit 6 also communicates with the reception computer 2 via the computer network 4 or the point-to-point connection 5. The latter is to be thereby preferred for reasons of data security.

The user computer 1 also has a voice input device 11. The user 10 can prescribe voice data for the user computer 1 with the voice input device 11. The user computer 1 stores the voice data in a voice datafile that it communicates to the reception computer 2.

The reception computer 2 also has a main unit 12. The main unit 12 runs a computer program product 13 that is stored in the reception computer 2.

In the framework of processing the computer program product 13, the main unit 12 communicates with an operator 14 of the reception computer 2. For example, it can print out a text datafile 16 via a printer 15 or display the text datafile 16 via a monitor 17. In both instances, the text datafile 16 is output to the operator 14 in optical form. The main unit 12 also is able to accept inputs from the operator 14 via a keyboard 18 and a mouse device 19.

The reception computer 2 also has an acoustic output device 20 and a corresponding control device 21. The acoustic output device 20 can, for example, be a speaker or a headset. Voice data, particularly a voice datafile communicated from the user computer 1, can be interactively output to the operator 14 via the acoustic output device 20. The interactivity is produced by the control device 21. For example, the control device 21 can be a foot switch and serves for the control of the output of the voice datafile.

The third-party computer 3 is of secondary significance in the framework of the present invention. The only relevancy thereof is that the text datafile 16 can be received by the third-party computer 3 when it is communicated from the reception computer 2.

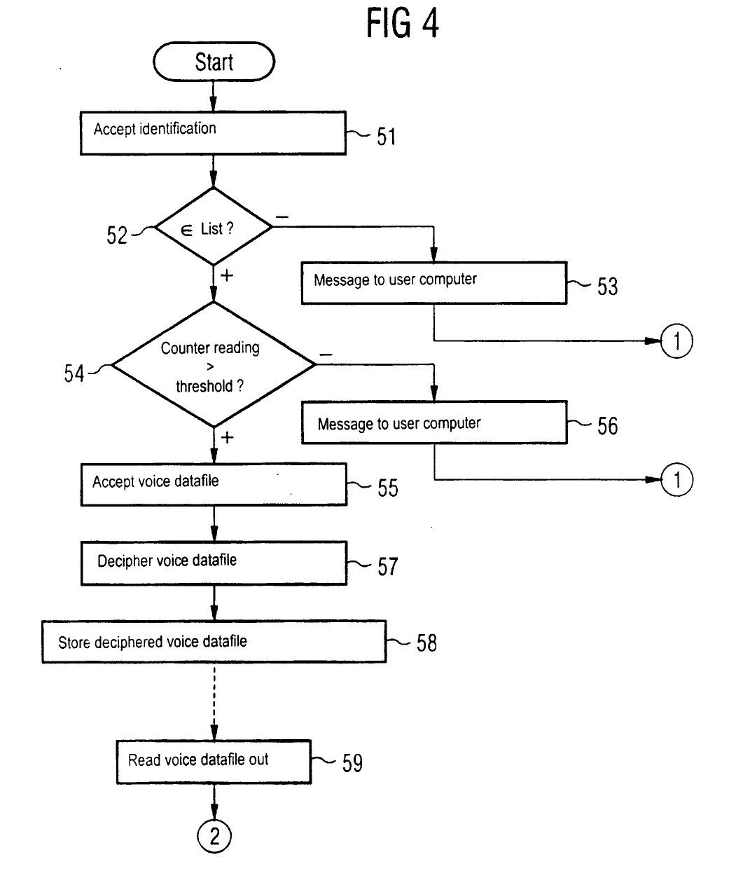

By running the computer program product 13, the reception computer 2 executes the operating method described below in conjunction with FIGS. 4 through 7.

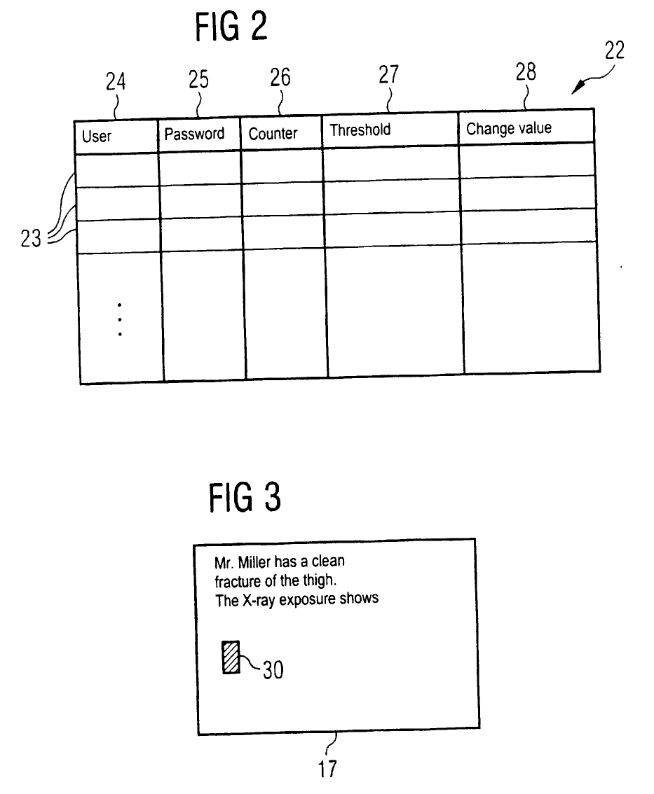

As shown in FIG. 4, the reception computer 2 first provisionally accepts an identification in a step 51. As is generally standard, the identification is composed of a user name and a password. In a step 52, the reception computer 2 then accesses a user list 22 (see FIG. 2). The user list 22 contains a number of lines 23. Each line 23 contains a number of entries 24 through 28. The entry 24, for example, corresponds a user name; the corresponding entry 25 corresponds to a password. By comparing the incoming user name and the incoming password to the authorizations deposited in the user list 22, a check can thus be performed to determine whether the user 10 is authorized to send voice data to the reception computer 2. If the communicated identification does not coincide with any of the authorizations stored in the user list 22, then the reception computer 2 automatically communicates a corresponding message to the user computer 1 in a step 53. Otherwise, a step 54 follows.

In step 54, a counter reading that is stored in the entry 26 is compared to a threshold that is deposited in the entry 27. When the counter reading exceeds the threshold, then a counter reading condition has been met. A step 55 is implemented in this case. Otherwise, the reception computer 2 automatically communicates a corresponding message to the user computer 1 in a step 56. As a result of the storage of the threshold in the entry 27, this can be identification-specific, however, it is also possible for the threshold to be the same for all counter readings.

In step 55, the reception computer 2 receives the voice datafile communicated from the user computer 1. The voice datafile is encrypted by the user computer 1 before the transmission. The reception computer 2 therefore first deciphers the voice datafile in a step 57. It then stores the voice datafile in a bulk storage 29 and thus archives it.

At a later point in time, i.e. time-offset, the reception computer 2 reads the voice datafile out of the bulk storage 29 in a step 59. The time offset is defined by the operator 14. It is indicated in FIG. 4 with a broken line between the steps 58 and 59. The production of the text datafile 16 is then undertaken after the readout of the voice datafile from the bulk storage 29.

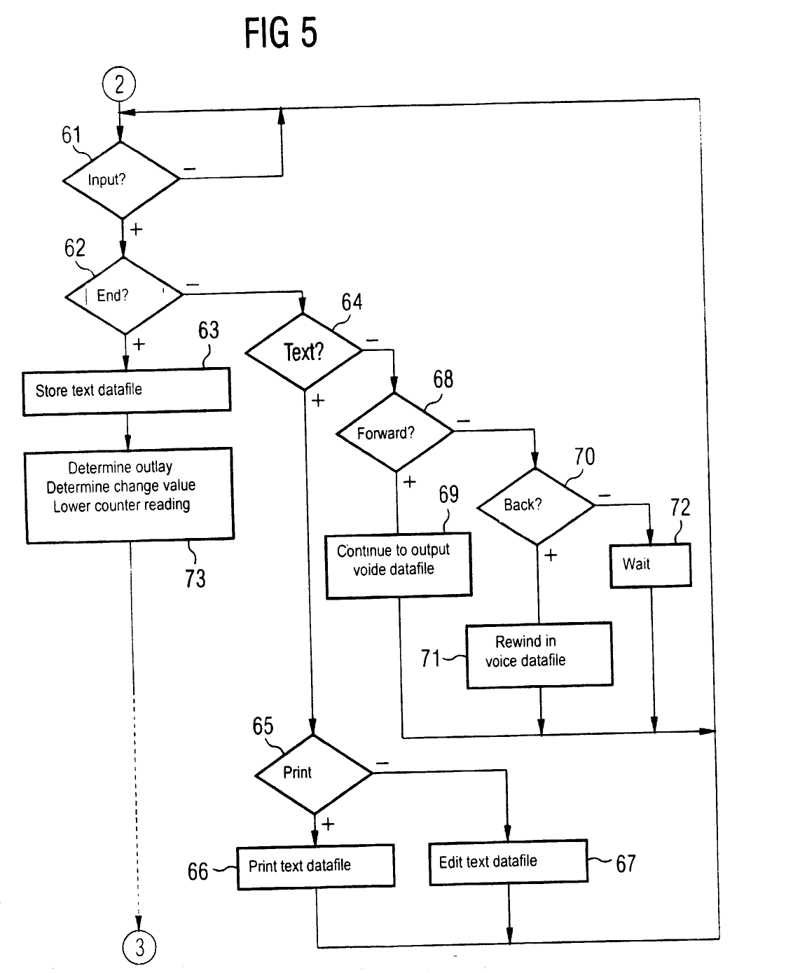

For producing the text datafile 16, a step 61 is first repeatedly executed according to FIG. 5 until an input by the operator 14 ensues. When an input has ensued, a query is made in a step 62 as to whether the routine for producing the text datafile 16 should be exited. If yes, a step 63 follows; otherwise, a step 64 follows.

A query is made in step 64 as to whether the input is a text input. In this case, the operator 14 made an entry via the keyboard 18 or the mouse device 19 which caused an input with respect to the text datafile 16 to ensue. In this case, a query is made in a step 65 as to whether the input was a print command. If yes, the text datafile 16 (or a selected portion of the text datafile 16) is printed out via the printer 15. Otherwise, an edit command was entered. This is executed in a step 67. A branch subsequently is made back to the step 61 regardless of whether the step 66 or the step 67 was executed.

As an example, FIG. 3 shows an excerpt from a text datafile 16 presented via the monitor 17. As can be seen from FIG. 3, the text datafile is for a patient-related medical situation. In terms of its informational content, the text datafile 16 corresponds to the communicated voice datafile. The voice datafile therefore also relates to a patient-related medical situation. A block 30 shown in FIG. 3 corresponds, for example, to a cursor that is movable in the framework of the editing of the text datafile 16.

If no text input ensues in the step 64, an input for the voice datafile ensued (via the control device 21). In this case, a query is first made in a step 68 as to whether it is a matter of a control command on the basis of which the output of the voice datafile should be continued via the acoustic output device 20. When this is the case, then the output is continued corresponding to a step 69.

Otherwise, a query is made in a step 70 as to whether the entry is a control command for the continuing rewind in the voice datafile. If yes, a rewind by some distance is made in the voice datafile in a step 71. The magnitude of the return can depend, for example, on how long the control command continues to be given.

If neither a control command for continuing an output of the voice datafile nor a control command for rewinding in the voice datafile was entered, the control command that was entered can basically only be a stop command. In this case, further output of the voice datafile is stopped in a step 72.

Regardless of whether the step 69, the step 71 or the step 72 was run, a branch is again made back to the step 61.

When a branch to the step 63 is made in the step 62, the text datafile 16 that has been produced is first stored in the bulk storage 29. It, too, is thus archived by the reception computer 2. A voice data-specific change value is then determined in a step 73, and the counter reading of the applicable authorization is correspondingly de-incremented. The change value can be determined, for example, from the scope of the text datafile 16 and/or of the voice datafile and/or from the time required for producing the text datafile 16.

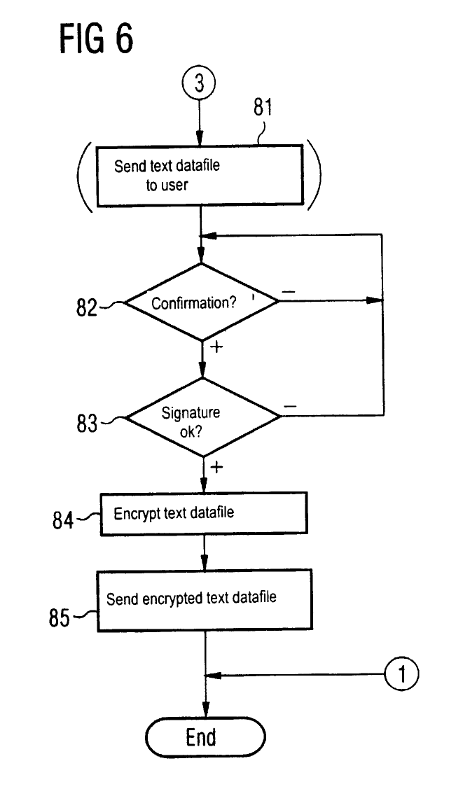

Next, the text datafile 16 is communicated to the user 10 in a step 81. This step is placed in brackets in FIG. 6 because it is not necessarily implemented by the reception computer 2. For example, a printout of the text datafile 16 can also be sent to the user 10 through the mails. An encrypted or unencrypted communication from the reception computer 2 to the user computer 1, however, also is within the inventive operating method.

Next, a step 82 is executed until the user computer 1 has communicated a confirmation to the reception computer 2. When the confirmation is sent, a check is made in a step 83 as to whether the confirmation comprises a digital signature and whether this signature is proper. A step 84 follows only when these conditions are met; otherwise, a branch is made back to the step 82.

The reception computer 2 encrypts the text datafile 16 in the step 84. In a step 85, it subsequently sends it to the user computer 1 or to some other computer, for example the third-party computer 3.

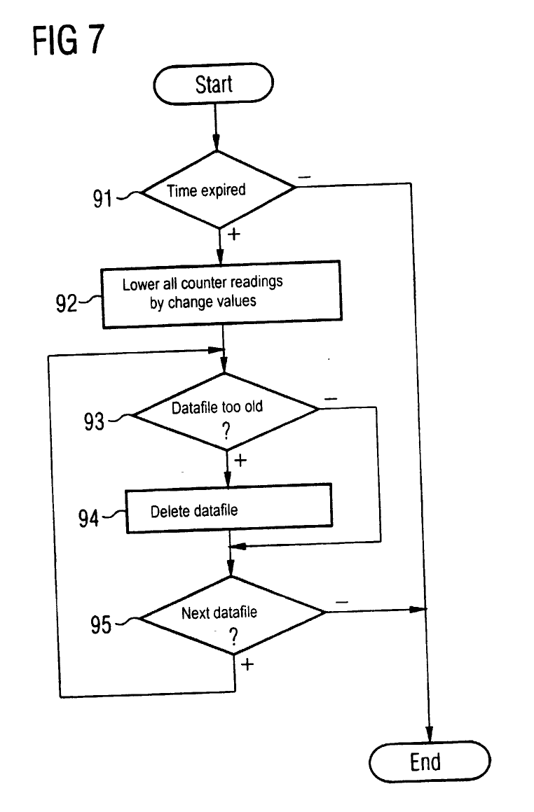

In the framework of the operating method, the reception computer 2 also implements a further routine according to FIG. 7, for example interrupt-controlled. In this routine, the reception computer 2 first checks in a step 91 whether a prescribed base time has elapsed (for example, a day, a week, a month or a year). If the base time has not yet elapsed, the routine is immediately exited. Otherwise, all counter readings of the user list 22 are de-incremented by change values in a step 92. The change values are thereby included in the entries 28. Because they are contained in the entries, the change values optionally can be authorization-specific or can be the same for all counter readings.

In a step 93, the reception computer 2 then checks to determine whether one of the voice and text datafiles 16 stored in the bulk storage 29 is older than a storage time. The storage time is usually longer than the base time and amounts to at least one year, typically several years, for example three, five, eight or ten years. Every datafile whose age exceeds the storage time is deleted in a step 94. A check is made in a step 94 to see whether all datafiles were checked. If no, a branch is made back to the step 93; otherwise, the routine is exited.

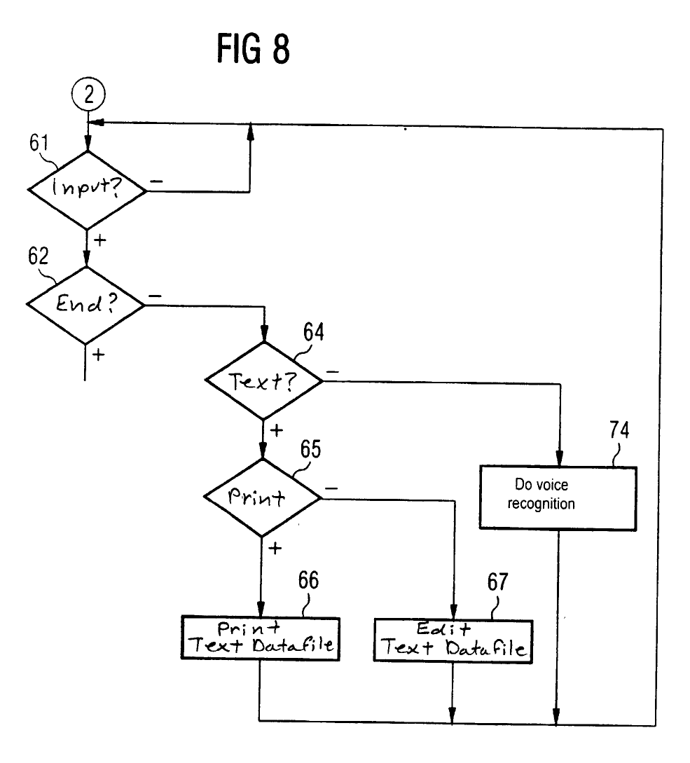

FIG. 8 shows an alternative form of producing the text datafile 16. According to FIG. 8, a single step 74 is implemented instead of the steps 68 through 72. In step 74, the reception computer 2 automatically produces the corresponding text datafile 16 on the basis of the communicated voice datafile. This occurs with ay known speech recognition system 31 (see FIG. 1).

As a result of the inventive operating method, a corresponding text datafile 16 can be produced from communicated voice data in a simple way.

Although modifications and changes may be suggested by those skilled in the art, it is the intention of the inventors to embody within the patent warranted hereon all changes and modifications as reasonably and properly come within the scope of their contribution to the art.

We claim as our invention:

1. An operating method for a reception computer, comprising the steps of:
providing access in a reception computer, via a data link selected from the group consisting of computer networks and point-to-point connections, to receive encrypted voice data from a user computer;
in said reception computer, deciphering said encrypted voice data to produce deciphered voice data; and
in said reception computer, generating a text data file from said deciphered voice data.

2. An operating method as claimed in claim 1 comprising providing said reception computer with a user interface, and acoustically communicating said deciphered voice data via said user interface to an operator, and wherein the step of producing a text datafile comprises interacting with said user operator via said user interface to produce said text datafile from inputs entered through said user interface by said operator.

3. An operating method as claimed in claim 1 wherein the step of producing a text datafile comprises automatically producing said text datafile in said reception computer from said deciphered voice data.

4. An operating method as claimed in claim 1 comprising receiving said encrypted voice data at said reception computer as a datafile.

5. An operating method as claimed in claim 1 comprising producing said text datafile time-offset relative to receipt of said encrypted voice data by said reception computer.

6. An operating method as claimed in claim 1 comprising the additional step of making said text datafile available from said reception computer to an operator in optical form via an output medium.

7. An operating method as claimed in claim 1 comprising the additional step of transmitting said text datafile from said reception computer to a third-party computer.

8. An operating method as claimed in claim 1 comprising transmitting said text datafile back to said user computer, as said third-party computer.

9. An operating method as claimed in claim 7 comprising transmitting said text datafile to said third party computer from said reception computer only if said user computer transmits a confirmation to said reception computer.

10. An operating method as claimed in claim 9 comprising incorporating a digital signature in said confirmation.

11. An operating method as claimed in claim 7 comprising encrypting said text datafile in said reception computer before transmission to said third party computer.

12. An operating method as claimed in claim 1 comprising receiving an identifier at said reception computer from said user computer in advance of transmission of said encrypted voice data, automatically comparing said identification in said reception computer to authorizations stored in a user list in said reception computer, and accepting said encrypted voice data at said reception computer only if the identification transmitted from said user computer coincides with an authorization in said user list.

13. An operating method as claimed in claim 12 comprising allocating a counter reading to said identification and, if said identification coincides with an authorization in said user list, checking, in said reception computer, said counter reading allocated to said identification to determine whether said counter reading satisfies a counter reading condition, and accepting said encrypted voice data from said user computer only if said counter reading condition is satisfied.

14. An operating method as claimed in claim 13 comprising determining that said counter reading satisfies said counter reading condition if said counter reading exceeds a threshold.

15. An operating method as claimed in claim 14 comprising employing an identification-specific threshold as said threshold.

16. An operating method as claimed in claim 14 comprising employing the same threshold for all counter readings respectively allocated to different identifications.

17. An operating method as claimed in claim 13 comprising automatically decrementing, in said reception computer, respective counter readings allocated to said authorizations by change values.

18. An operating method as claimed in claim 17 comprising employing authorization-specific change values as said respective change values.

19. An operating method as claimed in claim 17 comprising employing the same change values for all counter readings allocated to different identifications.

20. An operating method as claimed in claim 13 comprising decrementing, in said reception computer, a counter reading allocated to said identification by a voice data-specific change value.

21. An operating method as claimed in claim 1 comprising archiving at least one of said deciphered voice data and said text datafile in said reception computer, as archived data.

22. An operating method as claimed in claim 21 comprising deleting said archived data from said reception computer after expiration of a predetermined storage time.

23. An operating method as claimed in claim 1 comprising employing voice data relating to a patient-related medical situation as said encrypted voice data.

24. An operating method as claimed in claim 1 comprising employing an Internet protocol for communications between said reception computer and said user computer.

25. An operating method as claimed in claim 24 wherein said reception computer also communicates with a third-party computer, and employing said Internet protocol for communicating with said third party computer.

26. A computer program product loadable into a reception computer for configuring said reception computer to provide access, via a data link selected from the group consisting of computer networks and point-to-point connections, to receive encrypted voice data from a user computer, and to decipher said encrypted voice data to produce deciphered voice data, and to generate a text data file from said deciphered voice data.

27. A reception computer programmed with a computer program product, to:
provide access in said reception computer, via a data link selected from the group consisting of computer networks and point-to-point connections, to receive encrypted voice data from a user computer,
to decipher, in said reception computer, said encrypted voice data to produce deciphered voice data; and
to generate, in said reception computer, a text data file from said deciphered voice data.
